(19) United States
(12) Patent Application Publication
(10) Pub. No.: US 2025/0096649 A1
(43) Pub. Date: Mar. 20, 2025

(54) ROTATING ELECTRIC MACHINE

(71) Applicant: KABUSHIKI KAISHA TOSHIBA, Tokyo (JP)

(72) Inventors: Masaya HAGIWARA, Yokohama Kanagawa (JP); Kei MATSUOKA, Kawasaki Kanagawa (JP); Hiroaki KINOUCHI, Meguro Tokyo (JP); Shinya SAKURADA, Saitama Saitama (JP)

(73) Assignee: KABUSHIKI KAISHA TOSHIBA, Tokyo (JP)

(21) Appl. No.: 18/764,225

(22) Filed: Jul. 4, 2024

(30) Foreign Application Priority Data
Sep. 20, 2023 (JP) 2023-154016

(51) Int. Cl. H02K 9/22; H02K 1/16; H02K 3/12; H02K 5/04

(52) U.S. Cl. CPC H02K 9/22; H02K 1/16; H02K 3/12; H02K 5/04

(57) ABSTRACT

A rotating electric machine of an embodiment includes a stator, a rotor, a housing, and a cover member. The stator includes a stator core and a coil. The stator core includes a core back portion. The core back portion has an annular shape centered on a center axis. The coil is attached to the stator core. The coil is located on the radially inside of the core back portion. The coil includes a coil straight portion and a pair of coil end portions. The coil straight portion extends in a straight line shape along an axial direction. The pair of coil end portions respectively protrude from both axial end surfaces of the stator core in the axial direction. The cover member is attached to the stator. The cover member contacts the coil end portion and presses against the inner peripheral surface of the housing.

### BACKGROUND

### Field

Embodiments described herein relate generally to a rotating electric machine.

### Related Art

With the recent increasing awareness of environmental considerations, an aircraft having a propulsion fan driven by a rotating electric machine is being developed. The rotating electric machine for aircraft is required to be lightweight. Therefore, it is preferable to adopt an air cooling type as a cooling mechanism of the rotating electric machine for aircraft. Then, in this case, it is required to efficiently transfer the heat of a coil to a stator core.

### Patent Documents

[Patent Document 1] Japanese Unexamined Patent Application, First Publication No. 2017-153230

### BRIEF DESCRIPTION OF THE DRAWINGS

FIG. 1 is a cross-sectional view taken along a center axis of a rotating electric machine according to an embodiment.

FIG. 2 is a schematic cross-sectional view of a stator of the rotating electric machine according to the embodiment.

FIG. 3 is a schematic view when the stator of the rotating electric machine according to the embodiment is viewed from the inside in the radial direction.

FIG. 4 is a cross-sectional view of the rotating electric machine according to the embodiment when taken along a line IV-IV of FIG. 3.

FIG. 5 is a schematic view showing a configuration example of an aircraft.

### DETAILED DESCRIPTION OF THE INVENTION

Hereinafter, a rotating electric machine of an embodiment will be described with reference to the drawings.

The design of the rotating electric machine can be changed as appropriate to suit specifications and the like. Therefore, the shape and the like of each member included in the rotating electric machine can be changed arbitrarily, and the shape, number, and the like in the drawings are merely examples.

A rotating electric machine of an embodiment includes a stator, a rotor, a housing, and a cover member. The stator has an annular shape centered on a center axis. The rotor is located on a radially inside of the stator. The rotor is supported to be rotatable around the center axis. The housing accommodates the stator and the rotor. The housing has a tubular shape. The cover member is attached to the stator. The stator includes a stator core and a coil. The stator core includes a core back portion. The core back portion has an annular shape centered on the center axis. The coil is attached to the stator core. The coil is located on a radially inside of the core back portion. The coil includes a coil straight portion and a pair of coil end portions. The coil straight portion extends in a straight shape in an axial direction. The pair of coil end portions respectively protrude from both end surfaces of the stator core in the axial direction. The cover member includes a first cover portion. The first cover portion contacts one coil end portion so that the coil end portion is bent toward an inner peripheral surface of the housing and brought into contact with the inner peripheral surface of the housing.

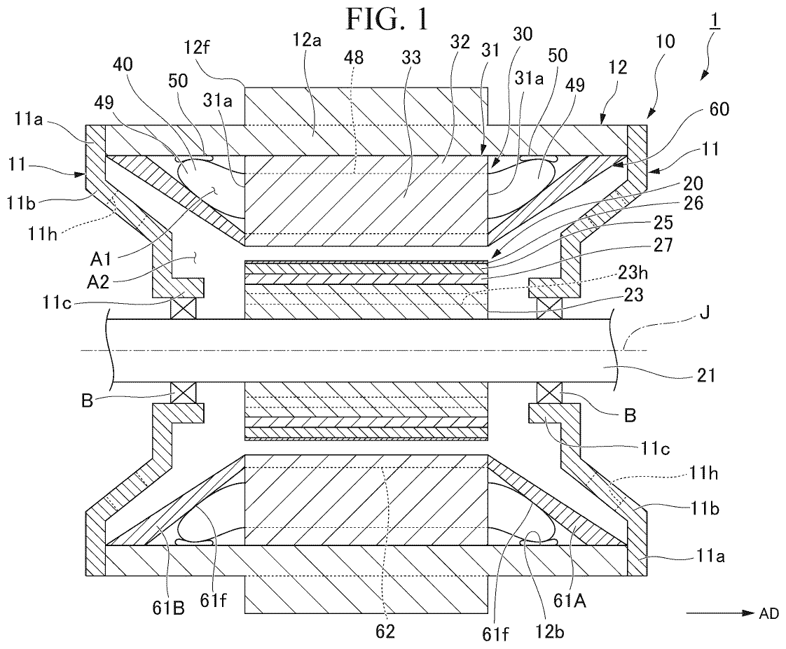

FIG. 1 is a cross-sectional view taken along a center axis J of a rotating electric machine 1 of this embodiment.

In the following description, the direction parallel to a center axis J is simply referred to as the “axial direction”, the radial direction centered on the center axis J is simply referred to as the “radial direction”, and the circumferential direction centered on the center axis J is simply referred to as the “circumferential direction θ”. Additionally, in each figure, the axial direction AD, the radial direction RD, and the circumferential direction θare illustrated as necessary. In each figure, the direction in which the arrow of the axial direction AD points is referred to as “one axial side (+AD)” and the opposite direction is referred to as the “other axial side (−AD).” Further, the direction in which the arrow of the radial direction RD points and approaches the center axis J is referred to as “radially inward (+RD),” and the opposite direction is referred to as “radially outward (−RD).”

The rotating electric machine 1 includes, for example, a stator 30 which has an annular shape centered on the center axis J, a rotor 20 which is located on the radially inside of the stator 30, a tubular housing 10 which accommodates the stator 30 and the rotor 20, and a cover member 60 that is attached to the stator 30. The rotating electric machine 1 of this embodiment is an inner rotor type rotating electric machine in which the rotor 20 is located on the radially inside of the stator 30.

The housing 10 includes, for example, a housing body 12 which extends in the axial direction and surrounds the stator 30 from the radially outside and a bearing holder 11 which is fixed to each of one axial end and the other axial end of the housing body 12.

The housing body 12 includes, for example, a cylindrical portion 12a which has a cylindrical shape centered on the center axis J and a plurality of radiation fins 12f which protrude radially outward from the outer peripheral surface of the cylindrical portion 12a. The cylindrical portion 12a contacts a stator core 31 of the stator 30 in an inner peripheral surface 12b. The heat of the stator 30 is transferred to the cylindrical portion 12a and is transferred from the cylindrical portion 12a to the radiation fin 12f. For example, the plurality of radiation fins 12f are arranged in the circumferential direction with a slight gap therebetween. For example, the gaps between the radiation fins 12f are opened on both sides in the axial direction. The rotating electric machine 1 is mounted on an aircraft 90, for example, in a posture in which the center axis J is parallel to the traveling direction of the aircraft 90. As the aircraft 90 flies, air passes through the gaps between the radiation fins 12f to cool the radiation fins 12f.

The bearing holder 11 has, for example, a disc shape centered on the center axis J. The pair of bearing holders 11 respectively cover the openings of the cylindrical portion 12a on both sides in the axial direction. The bearing holder 11 includes, for example, a fixed portion 11a, a tapered portion 11b, and a bearing holding portion 11c. The fixed portion 11a has, for example, an annular plate shape centered on the center axis J. The fixed portion 11a is fixed to, for example, an end surface of the cylindrical portion 12a facing the axial direction by a bolt (not shown).

The tapered portion 11b has, for example, a conical shape. The tapered portion 11b extends radially inward from the fixed portion 11a to be inclined toward the stator 30 in the axial direction AD. The tapered portion 11b is provided with, for example, a plurality of introduction holes 11h. The introduction hole 11h penetrates the tapered portion 11b in the axial direction AD. The plurality of introduction holes 11h allow the inner and outer spaces of the housing 10 to communicate with each other. For example, the air in the outer space is introduced into the inner space of the housing 10 through the introduction hole 11h of one bearing holder 11 to cool the rotor 20 and the stator 30. Further, the air warmed by the rotor 20 and the stator 30 is guided to the outside of the housing 10 through the introduction hole 11h of the other bearing holder 11. Furthermore, the tapered portion 11b does not have to be provided necessarily and the fixed portion 11a and the bearing holding portion 11c may be connected in a plane.

The bearing holding portion 11c has, for example, a cylindrical shape centered on the center axis J. A bearing B is held on the inner peripheral surface of the bearing holding portion 11c. The bearing B rotatably supports a shaft 21 of the rotor 20.

The rotor 20 is supported by the housing 10 to be rotatable around the center axis J. The rotor 20 includes, for example, the shaft 21 having the center axis J, a hub member 23, a rotor core 27, a magnet unit 25, and a cover 26.

The shaft 21 has, for example, a columnar shape extending in the axial direction about the center axis J. The hub member 23 has, for example, a tubular shape having a sufficient thickness in the radial direction. The hub member 23 is provided with, for example, a plurality of through-holes 23h penetrating in the axial direction. The hub member 23 is fixed to, for example, the outer peripheral surface of the shaft 21. Further, the rotor core 27 is fixed to, for example, the outer peripheral surface of the hub member 23.

The plurality of through-holes 23h can allow air to pass therethrough. As described above, the housing 10 is provided with the plurality of introduction holes 11h which allow the inner space and the outer space of the housing 10 to communicate with each other. A part of air entering the inner space of the housing 10 through the introduction hole 11h cools the rotor 20 when passing through the through-hole 23h.

The rotor core 27 is made of a magnetic material. The rotor core 27 is, for example, a laminated steel plate formed by laminating a plurality of electromagnetic steel plates in the axial direction. The rotor core 27 of the rotating electric machine 1 according to this embodiment has, for example, a cylindrical shape. The magnet unit 25 is disposed on the outer peripheral surface of the rotor core 27.

The magnet unit 25 has, for example, an annular shape. The magnet unit 25 can be fixed to, for example, the outer peripheral surface of the rotor core 27 by bonding means such as an adhesive. The rotor 20 of the rotating electric machine 1 according to this embodiment is of a surface magnet type in which the magnet unit 25 magnetically directly faces the stator 30. The configuration of the rotor 20 is not limited to this embodiment and the rotor may be, for example, of an embedded magnet type.

The magnet unit 25 includes a magnet with an S pole facing radially outward and a magnet with an N pole facing radially outward and has a configuration in which these magnets are arranged alternately in the circumferential direction. That is, the magnet unit 25 includes a plurality of magnets whose magnetization directions alternate in the circumferential direction. For example, the magnet unit 25 can be fixed to the outer surface of the rotor core 27 by bonding means such as an adhesive. Further, the magnet unit 25 is covered by the tubular cover 26. The cover 26 is made of a material that does not easily affect the magnetic force of the magnet unit 25.

The stator 30 surrounds the rotor 20 from the radially outside. The stator 30 includes, for example, the stator core 31, a coil 40, and an insulating member (not shown). The insulating member (not shown) insulates the coil 40 and the stator core 31 from each other. This insulating member may be, for example, an insulating paper. Further, this insulating member may be made of any one of resin, adhesive, glass cloth, insulating paper, and Kapton tape, or any other material as long as it is an insulating member.

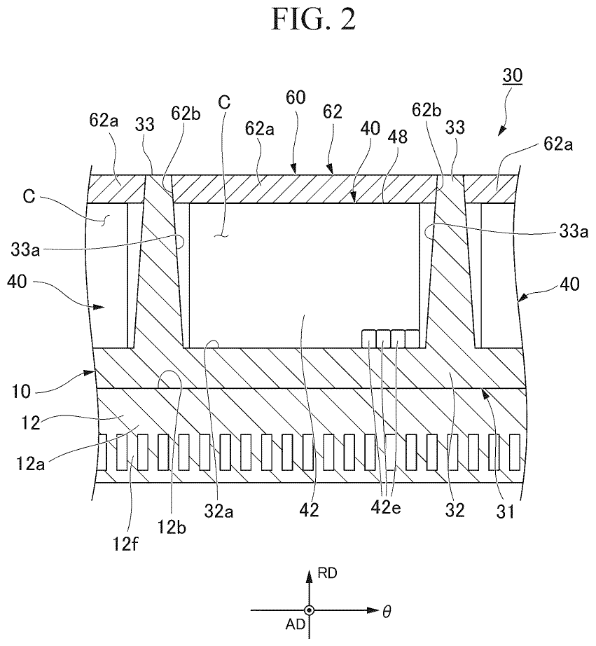

FIG. 2 is a schematic cross-sectional view of the stator 30 of the rotating electric machine 1 according to this embodiment. Furthermore, in FIG. 2, the circumferential direction is represented as a straight line.

The stator core 31 is, for example, a laminated steel plate formed by laminating a plurality of electromagnetic steel plates in the axial direction. The outer peripheral surface of the stator core 31 is in contact with the inner peripheral surface 12b of the cylindrical portion 12a of the housing 10. The heat of the stator 30 is transferred from the outer peripheral surface of the stator core 31 to the housing 10 and is radiated in the radiation fin 12f.

The stator core 31 includes, for example, a core back portion 32 and a plurality of protrusion portions 33. The stator core 31 is made of a magnetic material.

The core back portion 32 has, for example, an annular shape centered on the center axis J. The core back portion 32 has a support surface 32a facing radially outward. The coil 40 is disposed on the radially inside of the core back portion 32. For example, the support surface 32a supports the coil 40 from the radially outside with an insulating member (not shown) interposed therebetween. Furthermore, one insulating material selected from an insulating material group like an “insulating member 50 disposed between the coil end portion and the inner peripheral surface of the housing” described later can be used as the “insulating member provided between the coil 40 and the support surface 32a”. Further, the “insulating member provided between the coil 40 and the support surface 32a” and the “insulating member 50 disposed between the coil end portion and the inner peripheral surface of the housing” may be made of the same material or different materials.

The plurality of protrusion portions 33 protrude radially inward from the support surface 32a of the core back portion 32. The protrusion portion 33 has, for example, a rib shape extending in the axial direction. The plurality of protrusion portions 33 are arranged in the circumferential direction. The plurality of protrusion portions 33 protrude radially inward from the support surface 32a of the core back portion 32. A winding range C for disposing the coil 40 therein is provided between the protrusion portions 33 adjacent to each other in the circumferential direction. That is, the plurality of protrusion portions 33 partition the winding range C.

Since the stator core 31 of the rotating electric machine 1 according to this embodiment includes the protrusion portion 33 which partitions the arrangement region of the coil 40 in the circumferential direction, the displacement of the coil 40 in the circumferential direction can be suppressed. Further, since the protrusion portion 33 is made of a magnetic material, the magnetic flux formed in the radial direction between the rotor 20 and the stator 30 when driving the rotating electric machine 1 is likely to intensively pass through the protrusion portion 33. According to this embodiment, since it becomes difficult for the magnetic flux to pass through the coil 40, copper loss generated in the coil 40 can be suppressed and the driving efficiency of the rotating electric machine 1 can be improved.

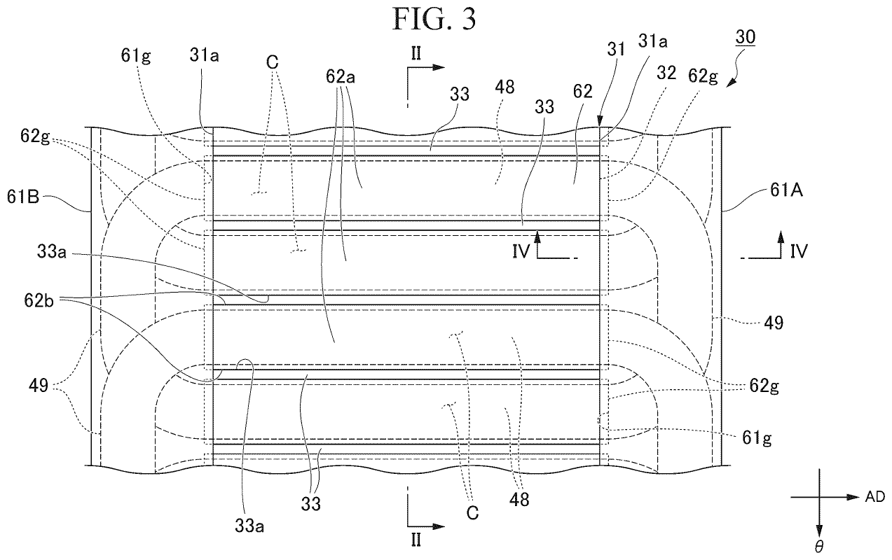

FIG. 3 is a schematic view of the stator 30 when viewed from the radially inside. Furthermore, FIG. 2 described above is a cross-sectional view taken along a line II-II of FIG. 3.

As shown in FIG. 3, the coil 40 is attached to the stator core 31. The coil 40 includes a coil straight portion 48 which is disposed in the winding range C and a pair of coil end portions 49 which respectively protrude in the axial direction from both axial end surfaces 31a of the stator core 31. The coil straight portion 48 is located on the radially inside (+RD) of the core back portion 32. The coil straight portion 48 extends in a straight line shape along the axial direction AD between the protrusion portions 33 adjacent to each other in the circumferential direction. The pair of coil end portions 49 are respectively connected to both axial sides of the coil straight portion 48. The coil end portion 49 is bent into a hairpin shape to connect the ends of the two coil straight portions 48 to each other.

The plurality of coils 40 are classified as multi-phase coils. Alternating currents with different phases flow through the coils 40 with different phases. The coils 40 of the rotating electric machine 1 according to this embodiment include three phase coils 40, and alternating currents with phases shifted by 120° are passed through these coils 40. Here, in order to illustrate and describe a three-phase AC rotating electric machine, the plurality of coils 40 are classified into three phases, but the number of phases is not limited to this embodiment. Further, the phase difference between the alternating currents flowing through the coils 40 of each phase is changed as appropriate depending on the number of phases. The coil 40 of the rotating electric machine 1 according to this embodiment is configured, for example, by distributed winding in which coils 40 of different phases overlap in the radial direction while being offset in the circumferential direction.

As shown in FIG. 2, the coil 40 includes a plurality of wires bundles 42. In the stator 30 of the rotating electric machine 1 according to this embodiment, the plurality of wires bundles 42 are arranged in the region between the pair of protrusion portions 33. Further, each wire bundle 42 is configured by bundling a plurality of coils wires 42e. That is, the coil 40 is configured by bundling the plurality of coils wires 42e. The coil wire 42e may be a round wire or a square wire, or may have a different cross-sectional shape. The wire bundle 42 constitutes the coil 40 by being wound in a loop shape multiple times between the protrusions 33. Although FIG. 2 shows an example in which the plurality of wires bundles 42 are arranged in the region between the pair of protrusion portions 33, the number of the wire bundles 42 arranged in the region between the protrusion portions 33 can be changed arbitrarily depending on the coil design.

As shown in FIG. 1, the cover member 60 is disposed inside the housing 10. The cover member 60 is preferably made of a material with excellent insulation properties. In this embodiment, the cover member 60 is made of a ceramic material.

The cover member 60 includes a pair of first cover portions 61A and 61B and a second cover portion 62.

The first cover portion 61A which is located on one axial side (+AD) in the pair of first cover portions 61A and 61B is located on one axial side and the radial inside of one coil end portion 49 located on one axial side (+AD) in the pair of coil end portions 49. The first cover portion 61B which is located on the other axial side (−AD) in the pair of first cover portions 61A and 61B is located on the other axial side and the radially inside of the other coil end portion 49 located on the other axial side (−AD) in the pair of coil end portions 49. In this embodiment, although the pair of first cover portions 61A and 61B have a symmetrical shape in the axial direction, it is not necessary for the first cover portions to have a strictly symmetrical shape, and deviations are allowed within a range that does not affect the design, performance, and the like of the rotating electric machine 1.

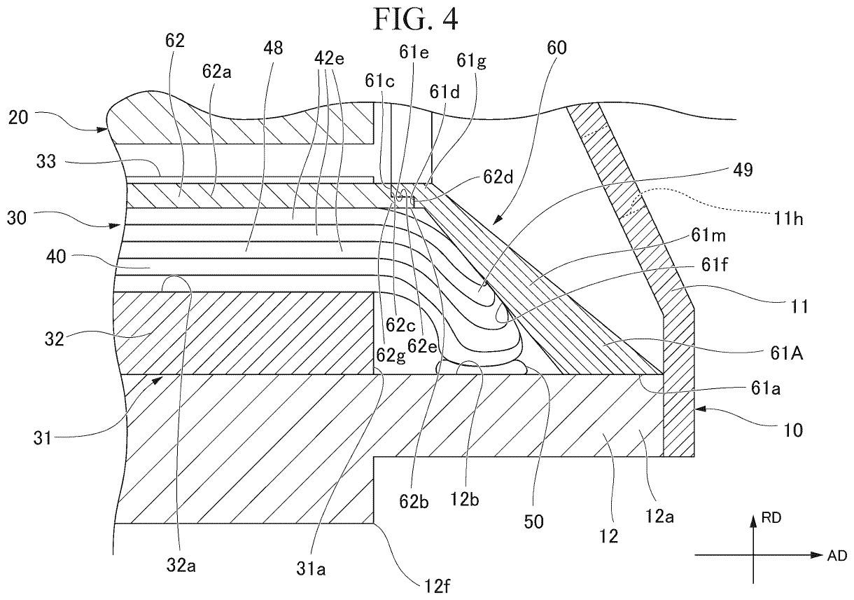

FIG. 4 is a cross-sectional view of the rotating electric machine 1 taken along a line IV-IV of FIG. 3.

In FIG. 4, only the first cover portion 61A located on one axial side (+AD) in the pair of first cover portions 61A and 61B is illustrated. In the following description, the shape of one first cover portion 61A will be described with reference to FIG. 4. In this embodiment, the other first cover portion 61B has a shape that is reversed in the axial direction compared to the first cover portion 61A to be described, so the description thereof will be omitted. Furthermore, this embodiment is an example, and the first cover portion 61B may have a shape that deviates from a strictly symmetrical shape within a range that does not affect performance or the like.

The first cover portion 61A has, for example, a uniform cross-sectional shape and extends in the circumferential direction θ centered on the center axis J. The first cover portion 61A includes, for example, a cover body portion 61m, a first joint 61a, and a first connecting portion 61g. The first cover portion 61A is in contact with at least the second cover portion 62 and the housing body 12. The first cover portion 61A of the rotating electric machine 1 according to this embodiment is in contact with the second cover portion 62 in the first connecting portion 61g and is in contact with the housing body 12 in the cover body portion 61m.

It is preferable that the cover body portion 61m has a tapered plate shape extending radially outward (−RD) as it goes toward the one axial side (+AD) when observed in a cross-section parallel to the one axial side (+AD). The cover body portion 61m covers an end surface 31a facing the axial direction AD of the stator core 31 from the axial direction. The thickness dimension of the cover body portion 61m gradually increases as it goes toward one axial side. Accordingly, it is easy to ensure sufficient joint strength with the housing 10 by ensuring a sufficient thickness of the first joint 61a to be described later. Furthermore, although the preferable shape of the cover body portion 61m is a tapered shape, the shape of the cover body portion 61m is not limited to this embodiment.

The cover body portion 61m is in contact with the housing body 12. The cover body portion 61m has a pressing surface 61f facing the other axial side (−AD) and the radially outside (−RD). That is, the first cover portion 61A has the pressing surface 61f. If the second cover portion 62 is in contact with the housing body 12, the shape of the cover body portion 61m does not matter. The pressing surface 61f is preferably a surface that slopes radially outward (−RD) as it goes toward one axial side (+AD). That is, the pressing surface 61f slows radially outward (−RD) as it goes away from the stator core 31 in the axial direction. The pressing surface 61f faces the end surface 31a directed the axial direction of the stator core 31 in the axial direction. Further, the pressing surface 61f faces and contact the coil end portion 49 in the axial direction AD and the radial direction RD. The coil end portion 49 is bent radially outward (−RD) by contacting the pressing surface 61f and is pressed against the inner peripheral surface 12b of the housing 10. Accordingly, the heat of the coil end portion 49 is released to the outside through the housing 10.

Further, the first cover portion 61A of the rotating electric machine 1 according to this embodiment contacts the coil end portion 49 in the pressing surface 61f. Therefore, a part of the heat of the coil end portion 49 is transferred to the first cover portion 61A and is released to the outside through the first cover portion 61A. Further, this heat is released from the first cover portion 61A to the outside through the housing 10. That is, the heat of the coil end portion 49 is released to the outside through a path in which the heat is transferred through the first cover portion 61A and a path in which the heat is transferred from the first cover portion 61A to the housing 10 in addition to a path in which the heat is directly transferred to the housing 10.

Furthermore, in the present specification, “contact” refers not only to cases in which one member directly contacts the other member, but also to cases in which one member and the other member come into thermal contact through an intervening material. “Thermal contact” here means a state in which heat from one member is quickly transferred to the other member. Furthermore, heat is “transferred quickly” between members means that the heat transfer rate is at least faster than when the members are separated from each other through an air layer.

The insulating member 50 that insulates the coil end portion 49 and the housing 10 from each other is disposed between the coil end portion 49 and the inner peripheral surface 12b of the housing 10. The insulating member 50 may be, for example, an insulating resin member. The insulating member 50 may be made of any one of resin, adhesive, glass cloth, insulating paper, and Kapton tape, or any other material as long as it is an insulating member. Further, an insulating coating may be provided on the inner peripheral surface 12b of the housing 10 or the surface of the coil wire 42e instead of arranging the insulating member 50 or in addition to arranging the insulating member 50.

The first joint 61a is provided at the end on one axial side (+AD) of the cover body portion 61m. The first joint 61a of the rotating electric machine 1 according to this embodiment is in contact with the inner peripheral surface 12b of the cylindrical portion 12a of the housing 10. The first joint 61a can be fixed to, for example, the inner peripheral surface 12b of the cylindrical portion 12a by bonding means such as an adhesive. In this embodiment, the first joint 61a and the cylindrical portion 12a are preferably joined in an airtight manner over the entire circumference in the circumferential direction. Thus, the first cover portion 61A suppresses the passage of air in the boundary portion between the first joint 61a and the cylindrical portion 12a. Furthermore, in this embodiment, a case is illustrated in which the first joint 61a is directly adhesively fixed to the inner peripheral surface 12b, but the first joint 61a may be fixed to the inner peripheral surface 12b of the housing 10 by other means.

The first connecting portion 61g is provided at the end on the other axial side (−AD) of the cover body portion 61m. The first connecting portion 61g is connected to the second cover portion 62. The first connecting portion 61g has, for example, a first end surface 61c and a second end surface 61d facing the other axial side (−AD), and a first connecting surface 61e facing radially outward (−RD). The first end surface 61c, the second end surface 61d, and the first connecting surface 61e are arranged in a stepped manner. Therefore, the first cover portion 61A and the second cover portion 62 are joined in the first connecting portion 61g. The first end surface 61c and the second end surface 61d are flat surfaces orthogonal to the center axis J. Further, for example, the first end surface 61c and the second end surface 61d extend in an annular shape centered on the center axis J. The first end surface 61c is located on the other axial side (−AD) and the radially inside (+RD) than the second end surface 61d. The first connecting surface 61e is, for example, a cylindrical surface extending in the circumferential direction about the center axis J. The first connecting surface 61e connects the end on the radially outside (−RD) of the first end surface 61c and the end on the radially inside (+RD) of the second end surface 61d.

The second cover portion 62 is located on the radially inside (+RD) of the stator core 31 and the coil straight portion 48. As shown in FIG. 3, the second cover portion 62 preferably has a plurality of divided portions 62a. The plurality of divided portions 62a are arranged in parallel in the circumferential direction. The plurality of divided portions 62a are respectively located between the protrusion portions 33. The divided portion 62a has, for example, a plate shape extending in the axial direction to be orthogonal to the radial direction. The entire length of the divided portion 62a in the axial direction AD is slightly larger than the entire length of the stator core 31 in the axial direction AD. Both axial ends (second connecting portions 62g to be described later) of the divided portion 62a respectively protrude from the end surface 31a of the stator core 31 directed to the axial direction.

As shown in FIG. 2, a surface of the divided portion 62a facing the radially inside (+RD) faces the support surface 32a of the core back portion 32 in the radial direction RD. The coil straight portion 48 is disposed between the core back portion 32 and the second cover portion 62 in the radial direction RD. The divided portion 62a presses the coil straight portion 48 against the core back portion 32. That is, the second cover portion 62 applies a surface pressure to the coil straight portion 48 to be pressed against the core back portion 32. Accordingly, the coil straight portion 48 closely contacts the support surface 32a of the core back portion 32. Further, since the coil 40 is constituted by the plurality of coils wire 42e, a part of the coil wire 42e expands in the circumferential direction by applying a surface pressure radially inward (+RD) from the second cover portion 62. Accordingly, a part of the coil wire 42e is pressed against a protrusion side surface 33a of the protrusion portion 33. That is, according to this embodiment, since the contact area between the coil straight portion 48 and the stator core 31 increases, the heat of the coil straight portion 48 is likely to be transferred to the stator core 31. Accordingly, the coil 40 can be efficiently cooled.

As shown in FIG. 3, the divided portion 62a includes a pair of second joints 62b which are located at both circumferential ends and the pair of second connecting portions 62g which are located at both axial ends.

As shown in FIG. 2, the second joint 62b contacts the circumferentially facing protrusion side surface 33a of the protrusion portion 33 of the housing 10. For example, the second joint 62b can be fixed to the protrusion side surface 33a by bonding means such as an adhesive. In this embodiment, it is preferable that the second joint 62b and the protrusion side surface 33a are joined in an airtight manner over the entire length in the axial direction. Thus, the second cover portion 62 suppresses the passage of air at the boundary portion between the second joint 62b and the protrusion portion 33. Furthermore, in this embodiment, a case is illustrated in which the second joint 62b is directly adhesively fixed to the protrusion side surface 33a, but the second joint 62b may be fixed to the protrusion side surface 33a by other means.

As shown in FIG. 3, the pair of second connecting portions 62g are provided on both axial sides of the divided portion 62a and have a symmetrical shape in the axial direction. Furthermore, this embodiment is an example, and the pair of second connecting portions 62g may have a shape that deviates from a strictly symmetrical shape within a range that does not affect performance or the like. One of the pair of second connecting portions 62g on one axial side is connected to the first cover portion 61A on one axial side in the pair of first cover portions 61A and 61B. The other of the pair of second connecting portions 62g on the other axial side is connected to the first cover portion 61B on the other axial side in the pair of first cover portions 61A and 61B. In the following description, only one of the pair of second connecting portions 62g on one axial side will be described, and description of the other having a shape reversed in the axial direction will be omitted.

As shown in FIG. 4, the second connecting portion 62g includes, for example, a third end surface 62c and a fourth end surface 62d facing one axial side (+AD) and a second connecting surface 62e facing the radially inside (+RD). The third end surface 62c, the fourth end surface 62d, and the second connecting surface 62e are arranged in a stepped manner. The third end surface 62c and the fourth end surface 62d are flat surfaces orthogonal to the center axis J. Further, for example, the third end surface 62c and the fourth end surface 62d extend in an annular shape centered on the center axis J. The third end surface 62c is located on the other axial side (−AD) and the radially inside (+RD) than the fourth end surface 62d. The second connecting surface 62e is, for example, a cylindrical surface extending in the circumferential direction about the center axis J. The second connecting surface 62e connects the end on the radially outside (−RD) of the third end surface 62c and the end on the radially inside (+RD) of the fourth end surface 62d.

In a state in which the first connecting portion 61g and the second connecting portion 62g are connected, the second connecting portion 62g is located on the radially inside of the first connecting portion 61g. Therefore, the movement of the second cover portion 62 toward the radially outside is restricted by the first cover portion 61A. Further, the first end surface 61c and the third end surface 62c face each other, the second end surface 61d and the fourth end surface 62d face each other, and the first connecting surface 61e and the second connecting surface 62e face each other.

The first end surface 61c and the third end surface 62c, the second end surface 61d and the fourth end surface 62d, and the first connecting surface 61e and the second connecting surface 62e are preferably fixed to each other by using an adhesive or the like. In this embodiment, the passage of air is preferably suppressed by an adhesive at the boundary portion between the first cover portion 61A and the second cover portion 62. In this embodiment, the first connecting portion 61g and the second connecting portion 62g are preferably air-tightly joined over the entire length in the circumferential direction. Further, in this embodiment, it is more preferable that the boundary portion between the axial end surface of the protrusion portion 33 and the first cover portion 61A is also air-tightly joined with an adhesive.

As shown in FIG. 3, the divided portion 62a of the rotating electric machine 1 according to this embodiment has the second connecting portion 62g located at each of the ends on one axial side (+AD) and the other axial side (−AD) and each second connecting portion 62g is joined to the first cover portions 61A and 61B. Further, as shown in FIG. 4, the second connecting portions 62g on both axial sides are respectively arranged on the radially outside (−RD) of the first connecting portion 61g. Thus, the movement of the divided portion 62a toward the radially inside (+RD) is restricted at both ends in the axial direction AD. Further, the divided portion 62a receives a force directed radially outward (−RD) from the first cover portions 61A and 61B at both ends in the axial direction AD. Accordingly, the divided portion 62a can stably apply a surface pressure to the coil straight portion 48.

As shown in FIG. 1, the inner space of the housing 10 is partitioned into the radially inner and outer spaces by the cover member 60. Here, in the inner space of the housing 10 partitioned by the cover member 60, the space on the radially outside (−RD) of the cover member 60 is referred to as a first space A1 and the space on the radially inside (+RD) of the cover member 60 is referred to as a second space A2. The coil 40 is disposed in the first space A1. Further, the rotor 20 is disposed in the second space A2.

The second space A2 in the rotating electric machine 1 according to this embodiment communicates with the outer space of the housing 10 by the introduction hole 11h. Therefore, when the aircraft 90 flies, air is introduced into the second space A2 through the introduction hole 11h, and the rotor 20 is cooled by the flow of this air. On the other hand, the passage of air through the first space A1 in the rotating electric machine 1 according to this embodiment is suppressed by the housing 10, the stator core 31, and the cover member 60. Therefore, even if the aircraft 90 rises into the sky, the air pressure in the first space A1 inside the rotating electric machine 1 mounted on the aircraft 90 is maintained at a higher air pressure than the air pressure in the second space A2. Generally, it is known that the discharge phenomenon of the coil 40 is more likely to occur when the pressure becomes low. According to this embodiment, since the air pressure in the first space A1 is maintained at a higher air pressure than the air pressure in the second space A2, it is possible to suppress electrical discharge from occurring in the coil 40 in the sky. Further, in this embodiment, since the coil 40 is disposed in the first space A1, the coil 40 cannot be directly cooled by air. On the other hand, in this embodiment, the first cover portions 61A and 61B press the coil end portion 49 against the inner peripheral surface 12b of the housing 10 and the second cover portion 62 press the coil straight portion 48 against the stator core 31. Accordingly, the heat of the coil 40 is efficiently cooled to the outside through the stator core 31 and the housing 10. Accordingly, even if the coil 40 cannot be directly cooled, the temperature of the coil 40 can be suppressed from becoming too high.

Hereinafter, the configuration and effect of the rotating electric machine 1 of this embodiment will be summarized.

The rotating electric machine 1 of this embodiment includes the stator 30, the rotor 20, the housing 10, and the cover member 60. The stator 30 has an annular shape centered on the center axis J. The rotor 20 is located on the radially inside (+RD) of the stator 30. The rotor 20 is supported to be rotatable around the center axis J. The housing 10 has a tubular shape accommodating the stator 30 and the rotor 20. The cover member 60 is attached to the stator 30. The stator 30 includes the stator core 31 and the coil 40. The stator core 31 includes the annular core back portion 32 centered on the center axis J. The coil 40 is attached to the stator core 31. The coil 40 includes the coil straight portion 48 and the pair of coil end portions 49. The coil straight portion 48 is located on the radially inside (+RD) of the core back portion 32 and extends in a straight line shape along the axial direction. The pair of coil end portions 49 respectively protrude in the axial direction from both axial end surfaces of the stator core 31. The cover member 60 includes the first cover portion 61A. The first cover portion 61A contacts one coil end portion 49 so that the coil end portion is bent toward the inner peripheral surface 12b of the housing 10 and brought into contact with the inner peripheral surface 12b of the housing.

In general, the coil end portion 49 generates a large amount of heat because the coil wires 42e are closely packed together. According to the above-described configuration, the first cover portion 61A bends the coil end portion 49 to be brought into contact with the inner peripheral surface 12b of the housing 10. Accordingly, the heat of the coil end portion 49 can be transferred to the housing 10. In addition, since the first cover portion 61A contacts the coil end portion 49, a part of the heat of the coil end portion 49 moves to the housing 10 through the first cover portion 61A. Accordingly, it is possible to suppress the temperature of the coil end portion 49 from increasing too much by cooling the coil end portion 49.

In the rotating electric machine 1 of this embodiment, the cover member 60 includes the second cover portion 62. The second cover portion 62 is located on the radially inside (+RD) of the coil straight portion 48. The second cover portion 62 applies a surface pressure radially outward (−RD) to the coil straight portion 48 to be brought into contact with the stator core.

According to this configuration, it is easy to ensure a wide contact area between the coil straight portion 48 and the stator core 31 by pressing the coil straight portion 48 against the stator core 31. Accordingly, it is possible to efficiently cool the coil straight portion 48 by transferring the heat of the coil straight portion 48 to the stator core 31. Furthermore, the heat transferred to the stator core 31 is released to the outside through the housing 10.

In the rotating electric machine 1 of this embodiment, the cover member 60 includes the pair of first cover portions 61A and 61B. The pair of first cover portions 61A and 61B are respectively located on the axially outside of the coil end portion 49 on one axial side (+AD) and the other axial side (−AD). The pair of first cover portions 61A and 61B are respectively located on the radially inside (+RD) of the second cover portion 62 at one axial end and the other axial end.

According to this configuration, the pair of first cover portions 61A and 61B suppress the separation of the second cover portion 62 toward the radially inside (+RD). Further, the pair of first cover portions 61A and 61B can press the second cover portion 62 against the coil straight portion 48 and the reliability of the contact between the second cover portion 62 and the coil straight portion 48 can be increased.

In the rotating electric machine 1 of this embodiment, the stator core 31 includes the plurality of protrusion portions 33. The plurality of protrusion portions 33 protrude radially inward (+RD) from the core back portion 32 and are arranged in the circumferential direction 0. The coil straight portion 48 extends in the axial direction AD between the protrusion portions 33 adjacent to each other in the circumferential direction. The second cover portion 62 includes the plurality of divided portions 62a. Each of the plurality of divided portions 62a is located between the protrusion portions 33.

According to this configuration, since the stator core 31 includes the protrusion portion 33, it is possible to reduce the magnetic flux passing through the coil 40 and to suppress the copper loss generated in the coil straight portion 48 between the protrusion portions 33. Further, since each divided portion 62a is disposed between the protrusion portions 33, the coil straight portion 48 between the divided portion 62a and the protrusion portion 33 can be pressed against the stator core 31. As a result, the heat of the coil straight portion 48 can be efficiently moved to the stator core 31.

In the rotating electric machine 1 of this embodiment, the cover member 60 includes the second cover portion 62 and the pair of first cover portions 61A and 61B. The second cover portion 62 is located on the radially inside (+RD) of the coil straight portion 48. The pair of first cover portions 61A and 61B are respectively connected to both axial ends of the second cover portion 62. The pair of first cover portions 61A and 61B are respectively located on the axially outside of the coil end portion 49 on one axial side (+AD) and the other axial side (−AD). The cover member 60 partitions the inside of the housing 10 into the first space A1 and the second space A2. The first space A1 is a space located on the radially outside than the cover member 60. The second space A2 is a space located on the radially inside than the cover member 60. The coil 40 is disposed in the first space A1. The rotor 20 is disposed in the second space A2.

According to this configuration, the cover member 60 partitions the inside of the housing 10 into the first space A1 in which the coil 40 is disposed and the second space A2 in which the rotor 20 is disposed. Accordingly, the periphery of the coil 40 and the periphery of the rotor 20 can be placed in different states. More specifically, the air pressure in the first space A1 can be maintained and the discharge of the coil 40 can be suppressed even in the upper atmosphere by sealing the first space A1. On the other hand, it is possible to cool the rotor 20 disposed in the second space A2 by opening the second space A2 to the outside air and introducing the outside air into the second space A2.

In the rotating electric machine 1 of this embodiment, the first cover portion 61A includes the pressing surface 61f which contacts the coil end portion 49. The pressing surface 61f slopes radially outward (−RD) as it goes away from the stator core 31 in the axial direction AD.

According to this configuration, since the tapered pressing surface 61f is provided, it is possible to press the coil end portion 49 against the inner peripheral surface 12b of the housing 10 to be uniform in the circumferential direction by inserting the first cover portion 61A into the housing 10 in the axial direction AD.

In the rotating electric machine 1 of this embodiment, the cover member 60 is made of a ceramic material. Ceramic materials that can be used as the cover member 60 are, for example, silicon nitride (SiN), aluminum nitride (AIN), silica (SiO₂), alumina (Al₂O₃), or a composite material of ceramic and metal.

In general, the ceramic material has excellent insulation properties. According to the above-described configuration, since the cover member 60 has insulating properties, the cover member 60 can be brought into direct contact with the coil 40. Further, according to the above-described configuration, since the cover member 60 has excellent thermal conductivity, the cover member can receive heat from the coil 40 and cool the coil 40. Furthermore, the heat transferred from the coil 40 to the cover member 60 can be released to the outside through the housing 10.

In the rotating electric machine 1 of this embodiment, the insulating member 50 is interposed between the coil end portion 49 and the inner peripheral surface 12b of the housing 10.

According to this configuration, even when a metal material with high thermal conductivity is used for the housing 10, a discharge from the coil end portion 49 to the housing 10 can be suppressed.

Furthermore, in the rotating electric machine 1 of this embodiment, a case in which the stator core 31 includes the protrusion portion 33 has been described, but the stator core 31 may or may not include the protrusion portion 33.

According to at least one of the above-described embodiments, since the cover member 60 is provided to bring the coil end portion 49 into contact with the inner peripheral surface 12b of the housing 10, it is possible to provide the rotating electric machine 1 capable of efficiently transferring the heat of the coil 40 to the housing 10.

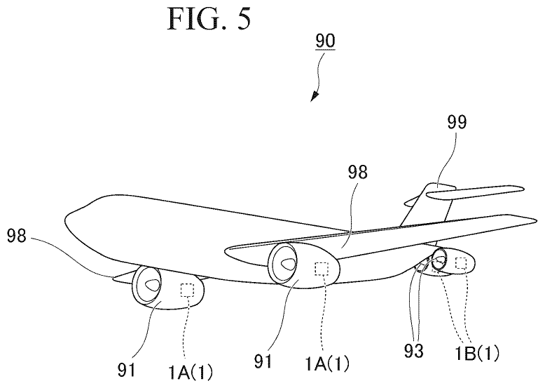

The above-described rotating electric machine can be mounted on various driving objects such as automobiles, railways, and aircraft. FIG. 5 is a schematic view of the aircraft 90 as an example of a driving object on which the rotating electric machine 1 is mounted. The aircraft 90 is a hybrid aircraft that is propelled by a combination of the jet engine 91 and the rotating electric machine 1. The aircraft 90 includes the pair of jet engines 91 and four rotating electric machines 1. The jet engine 91 is provided in a main wing 98. The jet engine 91 generates thrust by exhausting the air backward.

Four rotating electric machines 1 are classified into two power generating rotating electric machines 1A and two driving rotating electric machines 1B. Each power generating rotating electric machine 1A is connected to a main shaft of the jet engine 91. The power generating rotating electric machine 1A generates power by the jet engine 91. On the other hand, the driving rotating electric machine 1B is disposed below a vertical tail 99. The driving rotating electric machine 1B sends air backward and generates thrust by rotating the propulsion fan 93. The driving rotating electric machine 1B is driven by the power generated by the power generating rotating electric machine 1A. Furthermore, when the power generating rotating electric machine 1A generates surplus power, this power may be charged into a battery and used when necessary.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A rotating electric machine comprising:
a stator which has an annular shape centered on a center axis;
a rotor which is located on a radial inside of the stator, the rotor being supported to be rotatable around the center axis;
a tubular housing which is configured to accommodate the stator and the rotor; and
a cover member which is attached to the stator,
wherein the stator comprises:
a stator core which has a core back portion having an annular shape centered on the center axis; and
a coil which is attached to the stator core,
wherein the coil comprises:
a coil straight portion which is located on a radial inside of the core back portion, the coil straight portion extending in a form of straight line along an axial direction; and
a pair of coil end portions which respectively protrude from both axial end surfaces of the stator core in the axial direction, and
wherein the cover member comprises at least a first cover portion which contacts one coil end portion of the pair of coil end portions,
wherein the coil end portion is bent toward an inner peripheral surface of the housing, and
wherein the coil end portion is in contact with the inner peripheral surface of the housing.

2. The rotating electric machine according to claim 1,
wherein the cover member further comprises:
a second cover portion which is located on a radial inside of the coil straight portion, the second cover portion applies a surface pressure radially outward to the coil straight portion to make the coil straight portion into contact with the stator core.

3. The rotating electric machine according to claim 2,
wherein the at least first cover portion comprises:
a pair of first cover portions which are respectively located at radially-opposite outer-sides of the coil end portion, respectively, and
wherein the pair of first cover portions are respectively located at radially-opposite outer-sides of the second cover portion.

4. The rotating electric machine according to claim 2,
wherein the stator core comprises:
a plurality of protrusion portions which protrude radially inward from the core back portion, the plurality of protrusion portion being arranged in the circumferential direction, and
wherein the coil straight portion extends in the axial direction between the protrusion portions adjacent to each other in the circumferential direction and
wherein the second cover portion includes a plurality of divided portions which are respectively located between the protrusion portions.

5. The rotating electric machine according to claim 1,
wherein the cover member comprises:
a second cover portion which is located on a radial inside of the coil straight portion,
wherein the at least first cover portion comprises: a pair of first cover portions which are respectively connects to both axial ends of the second cover portion and are respectively located on an axially outside of the coil end portion on one axial side and the other axial side,
wherein the housing has a housing inside space, and the cover member partitions the housing inside space into a first space and a second space, the first space being located on a radially outside of the cover member, and the second space being located on a radially inside of the cover member,
wherein the coil is disposed in the first inside space, and
wherein the rotor is disposed in the second inside space.

6. The rotating electric machine according to claim 1,
wherein the first cover portion has a pressing surface which contacts the coil end portion, and
wherein the pressing surface is inclined radially outward as it goes away from the stator core in the axial direction.

7. The rotating electric machine according to claim 1,
wherein the cover member is made of a ceramic material.

8. The rotating electric machine according to claim 1,
wherein an insulating member is interposed between the coil end portion and the inner peripheral surface of the housing.
